(19) United States
(12) Patent Application Publication
(10) Pub. No.: US 2017/0243420 A1
(43) Pub. Date: Aug. 24, 2017

(54) ELECTRIC LOCK ADAPTED TO BE ACTIVATED BY A MOBILE PHONE AND METHOD THEREOF

(71) Applicant: WFE TECHNOLOGY CORP., Taichung City (TW)

(72) Inventor: Jack Lien, Taichung City (TW)

(21) Appl. No.: 15/047,017

(22) Filed: Feb. 18, 2016

(51) Int. Cl. G07C 9/00; E05B 47/00

(52) U.S. Cl. CPC G07C 9/00309; E05B 47/00; G07C 2009/00769; G07C 2009/00317; H04W 88/02

(57) ABSTRACT

Provided is an electric lock adapted to be activated by a mobile phone. The mobile phone includes a wireless connection module and a battery unit for supplying power to the wireless connection module and the electric lock includes a detection device, a control module and a wireless unlock module, wherein the detection device and the wireless unlock module are connected electrically to the control module and the wireless unlock module is configured to couple with the wireless connection module of the mobile phone via a wireless communication protocol such that once the wireless connection module of the mobile phone and the wireless unlock module of the electric lock are paired with each other, the mobile phone is capable of converting without touching awakening the wireless unlock module in order to unlock the electric lock relative to a locked object.

### BACKGROUND OF THE INVENTION

1. Field of the Invention

The present invention relates generally to an electric lock, and more particularly to a method and an electric lock that is adapted to be activated by a mobile phone, such as awakening the electric lock via a detection device for unlocking the electric lock from a locked object.

2. The Prior Arts

The Internet is a transforming communication and provides endless advances to new technical fields. The internet retailer or online retailing or buying goods online is one of the favorite topics among the consumers. Owing to the online retailing concept, several new mobile home appliances have been proposed endlessly so do the consumer electrical appliances.

Regarding the development of the electric lock field, the electric locks nowadays can go without the need of conventional keys. In other words, some methods have been proposed to unlock the electric locks without the implementation of conventional keys, such as unlocking an electric lock by touching one's human body part with the electric lock or via a wireless device which is configured electronically in such a manner to unlock the electric lock. Regarding the touching of one's human body part, a person finger or hand palm is used to touch the electric lock so as to cause an induced current for unlocking the electric lock. Note that touching of finger relative the electric lock generates a finger recognition data and the electric lock is unlocked when the preceding finger recognition data match with the stored ones. However, it is noted that the finger recognition ability can be affected adversely and fails to does its function due to improper input data or environmental weather or humidity, thereby failing to unlock the electric lock swiftly from a locked object.

Due to above-mentioned drawbacks, some wireless enabled devices (such as Bluetooth enabled devices) have been proposed and are configured electronically to unlock the electric lock from the locked object. It is to state that Bluetooth enabled devices may be installed in the electric locks such that the latter can be unlocked by wireless devices fabricated according to Bluetooth wireless communication technology. FIGS. 5 and 6 illustrate a presently existing electric lock 20 installed with Bluetooth enabled gadget 23 such that when a mobile phone user U is approaching toward the electric lock 20, the Bluetooth enabled gadget 23 will ceaselessly transmit wireless signals to the mobile phone 10. In case the mobile phone user U wishes the electric lock being unlocked, all he needs to do is activate the mobile phone 10 to transmit a wireless signal toward the electric lock 20, the electric lock 20 will be unlocked from the door frame upon the wireless signal being paired electronically with the wireless signal of the Bluetooth enabled gadget 23.

In the above-mentioned electric lock 20, the Bluetooth enabled gadget 23 is switched on all the time or constantly and ceaselessly transmits the wireless signal to an exterior so as to pair interactively and electronically with a corresponding mobile phone, if the latter is approaching to the former. We note that majority of power is consumed by the Bluetooth enabled gadget 23 due to ceaselessly transmitting of wireless signals, hence leading to frequent replacement of new batteries, resulting in extra expenses for the users of the currently existing electric locks.

### SUMMARY OF THE INVENTION

A primary objective of the present invention is to provide a method and an electric lock that is adapted to be activated by a mobile phone using Bluetooth wireless communication technology only upon the requirement of the user so as to avoid frequent replacement of new batteries. Another objective of the present invention is to provide a method using a mobile phone to awaken the electric lock from a sleeping mode only upon the requirement of the user so that a detection device of the electric lock can be disposed at a suspending mode at a relatively longer time due to avoiding ceaseless transmission of wireless signals threefrom, thereby economizing the battery power.

An electric lock of the present invention is adapted to be activated by a mobile phone. The invention is characterized in the followings.

The mobile phone includes a wireless connection module and a battery unit for supplying power to the wireless connection module.

The electric lock includes a detection device, a control module and a wireless unlock module, wherein, the detection device and the wireless unlock module are connected electrically to the control module. The wireless unlock module is configured electronically to couple with the wireless connection module of the mobile phone via a wireless communication protocol such that once the wireless connection module of the mobile phone and the wireless unlock module of the electric lock are paired with each other, the mobile phone is capable of awakening the wireless unlock module without touching from a sleeping mode in order to unlock the electric lock, thereby disengaging the electric lock from a locked object.

Preferably, the wireless connection module of the mobile phone and the wireless unlock module of the electric lock are electronically communicated relative to each other via Bluetooth wireless communication technology.

A method of the present invention for activating an electric lock by a mobile phone comprising the steps:

A detecting step using the mobile phone, where the mobile phone is capable of electronically unlocking the electric lock without touching upon approaching toward the electric lock if he desires so.

An awakening step, when the mobile phone user reaches a predetermine distance away from the electric lock, a detection device in the electric lock is capable of causing an induced current so as to activate a control module, which awakes a wireless unlock module of the electric lock from a sleeping mode.

A connecting and unlocking step, wherein after the wireless unlock module of the electric lock is awaken, the wireless unlock module of the electric lock is paired electronically with the wireless connection module of the mobile phone in such a manner to unlock the electric lock, thereby disengaging the electric lock from a locked object.

In the above-mentioned method, the wireless unlock module of the electric lock is being unlocked with respect to the locked object after being paired electronically with the wireless connection module of the mobile phone via Bluetooth wireless communication technology.

Preferably, in the detecting step S1 using the mobile phone, the phone user is required to activate the wireless connection module of the mobile phone prior to approaching toward the electric lock so as to be detected by the detection device of the electric lock.

Preferably, in the connecting and unlocking step, the phone user is required to awake the wireless unlock module of the electric lock from a sleeping mode prior to the wireless unlock module of the electric lock is being paired electronically with the wireless connection module of the mobile phone for unlocking the electric lock with respect to the locked object.

In this embodiment, the mobile phone is detected by the detection device of the electric lock once a distance between the mobile phone and the electric lock ranges 0.01 cm-20 cm.

The method and electric lock adapted to be activated by a mobile phone according the present invention provides the following advantages:

Due to installation of the wireless unlock module in the electric lock, the wireless unlock module is disposed at the sleeping mode in the normal condition and can be awaken by the control module only upon requirement by the mobile phone such that the electric lock can be unlocked due to induced current only after the wireless connection module of the mobile phone is being paired electronically with the wireless unlock module of the electric lock. Comparing with the prior art electric lock which is disposed at the suspending mode in the normal condition, the wireless unlock module of the present invention is disposed at the sleeping mode in the normal condition and can be awaken only upon the requirement, thereby saving the battery power of the electric lock of the present invention.

Since the wireless unlock module can be immediately awaken and is unlock from the locked object due to induced current after the electric lock and the mobile phone are paired electronically, a relatively large power can be saved when compared to the conventional electric lock, which utilizes touch recognition system. Hence, the unlocking method of the present invention can avoid frequent replacement of batteries.

### BRIEF DESCRIPTION OF THE DRAWINGS

The present invention will be apparent to those skilled in the art by reading the following detailed description of a preferred embodiment thereof, with reference to the attached drawings, in which:

FIG. 1 illustrates a block diagram representing an electric lock adapted to be activated by a mobile phone according to the present invention;

FIG. 2 is a block diagram illustrating the steps constituting a method for activating an electric lock by a mobile phone according to the present invention;

FIG. 3 illustrates a state where the electric lock is activated by the mobile phone due to approaching of the mobile phone toward the electric lock according to the present invention;

FIG. 4 illustrates a state where the electric lock is activated by the mobile phone to put the former in an awaken situation and is immediately unlocked when the electric lock and the mobile phone are paired electronically according to the present invention;

FIG. 5 is a block diagram illustrating the steps for activating an electric lock by a mobile phone via Bluetooth wireless communication technology in the prior art; and

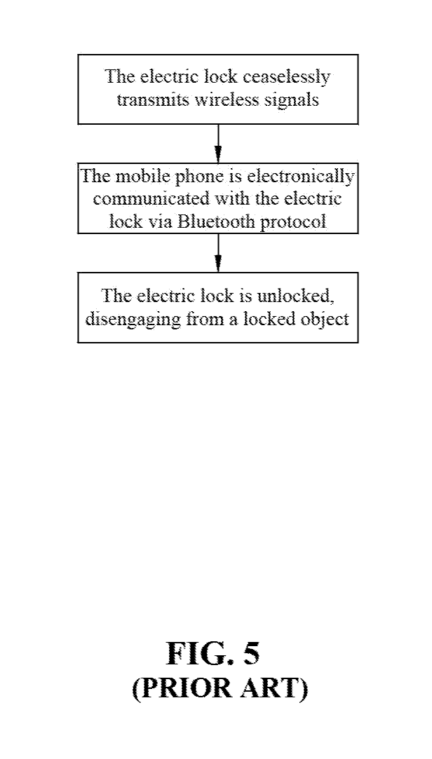

FIG. 6 illustrates a state where the electric lock of FIG. 5 is unlocked by the mobile phone upon reaching a set distance since the mobile phone is constantly communicated with the electric lock via Bluetooth protocol during approaching of the mobile phone toward the electric lock.

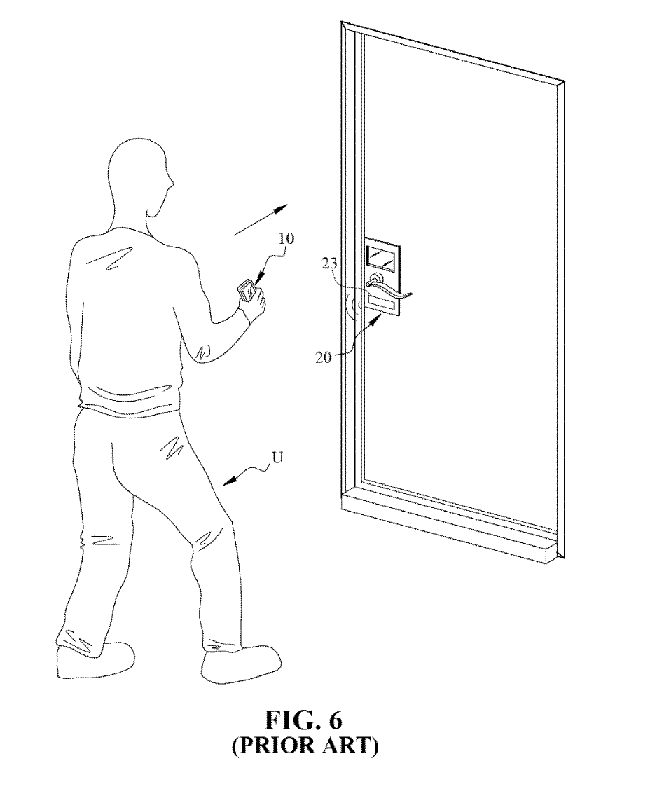

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

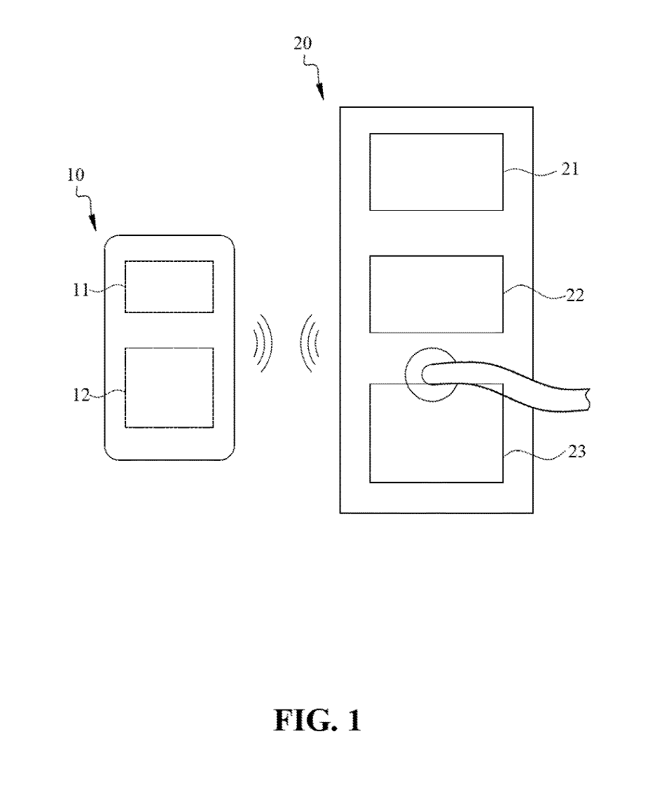

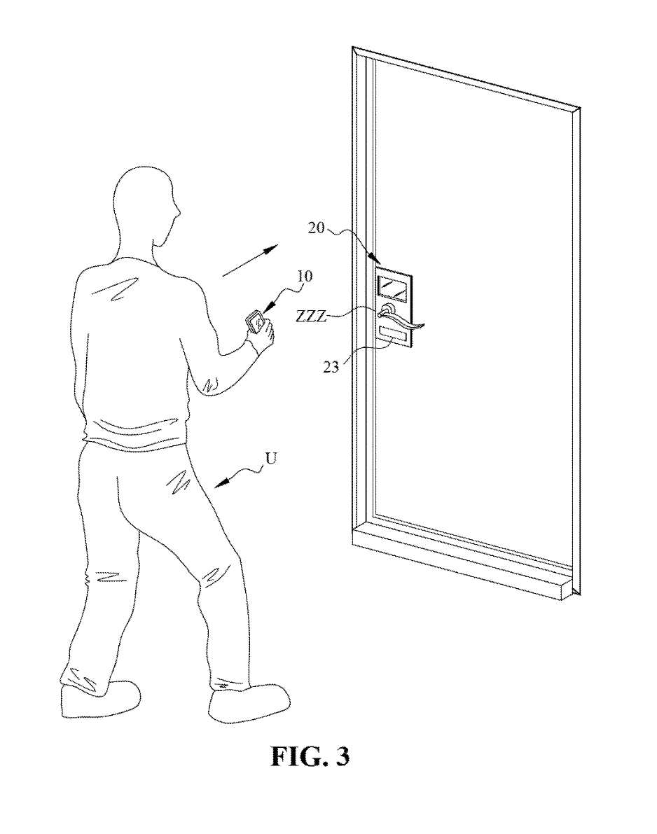

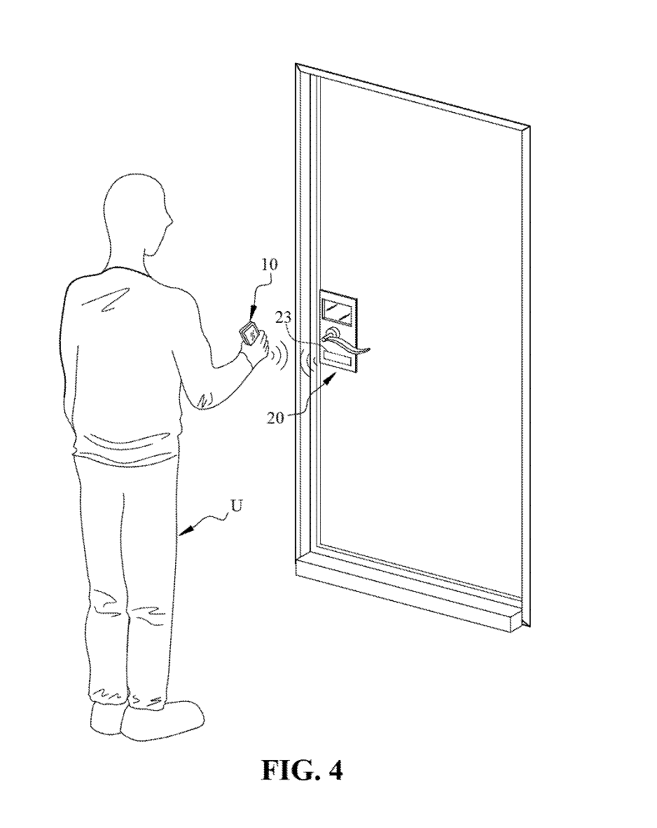

Referring to FIGS. 1, 3 and 4, wherein FIG. 1 illustrates a block diagram representing an electric lock 20 adapted to be activated by a mobile phone 10 according to the present invention; FIG. 3 illustrates a state where the electric lock 20 is activated by the mobile phone 10 due to approaching of the mobile phone 10 toward the electric lock 20 according to the present invention; and FIG. 4 illustrates a state where the electric lock 20 is activated by the mobile phone 10 to put the former in an awaken situation and is immediately unlocked from a locked body (not visible) when the electric lock 20 and the mobile phone 10 are paired electronically according to the present invention. As illustrated, an electric lock 20 is adapted to be activated by a mobile phone 10 according to the present invention.

The mobile phone 10 may be a smart phone. The mobile phone 10 includes a wireless connection module 11 and a battery unit 12 for supplying power to the wireless connection module 11. In this embodiment, the wireless connection module 11 is fabricated to compatible with Bluetooth wireless communication technology, which is a short range data communications platform for connecting many devices or Near Field Communication (NFC) technology, which is a short-range RF (radio frequency) communication standard or ZigBee, which is an IEEE 802.15.4-based specification for high-level communication protocols or Wi-Fi, which is a local area wireless computer networking technology that allows electronic devices to connect to the network. To be more specific, the present the wireless connection module 11 is fabricated to compatible with Bluetooth wireless communication technology or Near Field Communication (NFC) technology. Under this condition, the mobile phone 10 can be switched off or on automatically and manually in order to transmit a wireless signal.

The electric lock 20 is installed to the door for locking to an object (the door frame herein). The electric lock 20 includes a detection device 21, a control module 22 and a wireless unlock module 23, wherein the detection device 21 and the wireless unlock module 23 are connected electrically to the control module 22. Preferably, the detection device 21 is selected from a group consisting of Radio-frequency identification device (RFID) which uses wireless and electromagnetic fields to transfer data for automatically identifying and tracking signal (herein wireless signal from the mobile phone) while a microcontroller serves as the control module 22 for controlling operation and functions of all electronic gadgets hence serving as a central hub. In addition, the wireless unlock module 23 is configured to couple with the wireless connection module 11 of the mobile phone 10 via a wireless communication protocol or NFC protocol. To be more specific, the wireless unlock module 23 is fabricated to be compatible with Bluetooth wireless communication technology which generally utilizes less power source, hence providing a longer suspending time in addition to possession of awakening property so that it is suitable for implementing in the electric lock 20 of the present invention such that once the wireless connection module 11 of the mobile phone 10 and the wireless unlock module 23 of the electric lock 20 are paired electronically with each other, the mobile phone 10 is capable of awakening the wireless unlock module 23 without touching (from a sleeping mode) in order to unlock the electric lock 20, thereby disengaging the electric lock 20 from a locked object.

A method according to the present invention is proposed herein for activating an electric lock by a mobile phone. The method according includes the following steps: a detecting step Si using the mobile phone, an awakening step S2 and a connecting and unlocking step S3.

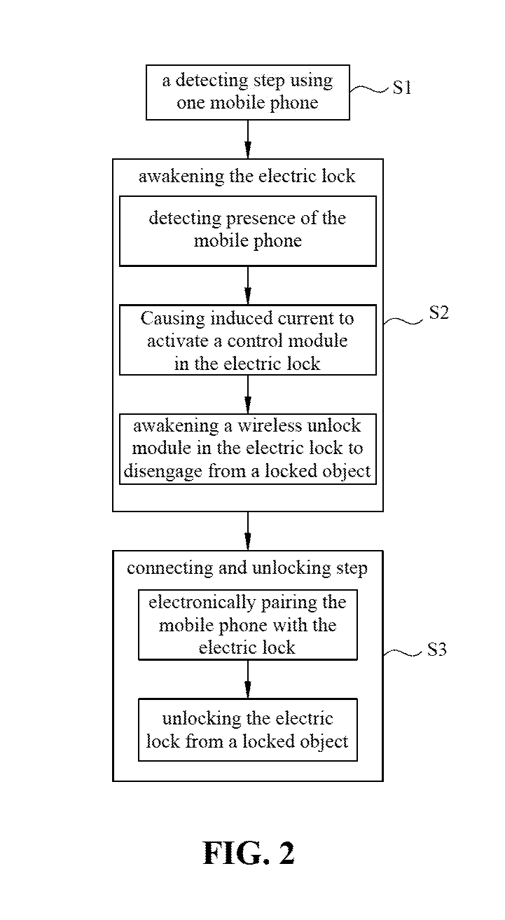

Referring again to FIGS. 2 and 3, in the detecting step S1 using the mobile phone, wherein a mobile phone 10 serves as the mobile phone is capable of electronically unlocking the electric lock 20 without touching. To be more specific, upon approaching toward the electric lock 20 and if the mobile phone user U desires so when arriving at a distance 5-50 cm from the electric lock 20, presence of the mobile phone 10 is detected by the electric lock 20 once the mobile phone 10 transmits a wireless signal via the antenna or the metal case of the mobile phone in case the metal case serves the purpose of an antenna.

In the awakening step S2, when the phone user reaches a predetermine distance away from the electric lock 20, the detection device 21 in the electric lock 20 is capable of causing an induced current so as to activate a control module 22, which awakes the wireless unlock module 23 of the electric lock 20 from a sleeping mode into a suspending mode.

In the connecting and unlocking step S3, as best shown in FIG. 4, wherein after the wireless unlock module 23 of the electric lock is awaken, the wireless unlock module 23 of the electric lock 20 is paired electronically with the wireless connection module 11 of the mobile phone 10 in such a manner that the mobile phone user U uses some software integrated in the electric lock 20 so as to unlock the electric lock 20, thereby disengaging the electric lock 20 from a locked object.

In this unlocking method, note that in the detecting step S1 using the mobile phone, the phone user U is required to activate the wireless connection module 11 of the mobile phone 10 prior to approaching toward the electric lock 20 and in the connecting and unlocking step S3, the phone user U is required to awake the wireless unlock module 23 of the electric lock 20 from a sleeping mode prior to the wireless unlock module 23 of the electric lock is being paired electronically with the wireless connection module 11 of the mobile phone 10 for unlocking the electric lock 20 with respect to the locked object.

In other words, the wireless unlock module 23 of the electric lock 20 can be paired electronically with the wireless connection module 11 of the mobile phone 10 only after the wireless unlock module 23 of the electric lock 20 is awaken from a sleeping mode into a suspending mode for unlocking the electric lock 20, thereby disengaging from the locked object (the door frame).

One aspect of the present invention resides in that since the wireless unlock module 23 of the electric lock 20 stays at the sleeping mode in the normal condition and can be immediately awaken and is disposed at the suspending mode for unlocking from the lock object due to induced current after the electric lock 20 and the mobile phone 10 are paired electronically, a relatively large power can be saved such that the electric lock 20 of the present invention can also stay at the suspending mode for a relatively long time when compared to the conventional electric lock, which utilizes touch recognition system and which generally stays at the suspending mode in the normal condition. Hence, the unlocking method of the present invention can avoid frequent replacement of battery.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An electric lock adapted to be activated by a mobile phone,
the mobile phone including a wireless connection module and a battery unit for supplying power to the wireless connection module;
the electric lock including a detection device, a control module and a wireless unlock module, wherein the detection device and the wireless unlock module are connected electrically to the control module, the wireless unlock module being configured to couple with the wireless connection module of the mobile phone via a wireless communication protocol such that once the wireless connection module of the mobile phone and the wireless unlock module of the electric lock are paired with each other, the mobile phone is capable of awakening the wireless unlock module without touching in order to unlock the electric lock, thereby disengaging the electric lock from a locked object.

2. The electric lock adapted to be activated by the mobile phone lock according to claim 1, wherein the wireless connection module of the mobile phone and the wireless unlock module of the electric lock are electronically communicated relative to each other via Bluetooth wireless communication technology.

3. The electric lock adapted to be activated by the mobile phone according to claim 1, wherein the wireless connection module of the mobile phone and the wireless unlock module of the electric lock are electronically communicated relative to each other vi Near Field Communication (NFC) technology.

4. A method for activating an electric lock by a mobile phone comprising the steps:
a detecting step S1 using the mobile phone, wherein the mobile phone is capable of electronically unlocking the electric lock without touching upon approaching toward the electric lock if a phone user desires so;
an awakening step S2, when the phone user reaches a predetermine distance away from the electric lock, a detection device in the electric lock is capable of causing an induced current so as to activate a control module, which awakes a wireless unlock module of the electric lock from a sleeping mode; and
a connecting and unlocking step S3, wherein after the wireless unlock module of the electric lock is awaken, the wireless unlock module of the electric lock is paired electronically with the wireless connection module of the mobile phone in such a manner to unlock the electric lock, thereby disengaging the electric lock from a locked object.

5. The method for activating the electric lock by the mobile phone according to claim 4, wherein the wireless unlock module of the electric lock is being unlocked with respect to the locked object after being paired electronically with the wireless connection module of the mobile phone via Bluetooth wireless communication technology.

6. The method for activating the electric lock by the mobile phone according to claim 4, wherein the wireless unlock module of the electric lock is being unlocked with respect to the locked object after being paired electronically with the wireless connection module of the mobile phone via Near Field Communication (NFC) technology.

7. The method for activating the electric lock by the mobile phone according to claim 4, wherein in the detecting step Si using the mobile phone, the phone user is required to activate the wireless connection module prior to approaching toward the electric lock so as to be detected by the detection device.

8. The method for activating the electric lock by the mobile phone according to claim 4, wherein in the connecting and unlocking step S3, the phone user is required to awake the wireless unlock module of the electric lock from a sleeping mode prior to the wireless unlock module of the electric lock is being paired electronically with the wireless connection module of the mobile phone for unlocking the electric lock with respect to the locked object.

9. The method for activating the electric lock by the mobile phone according to claim 4, wherein the mobile phone is detected by the detection device of the electric lock once a distance between the mobile phone and the electric lock ranges 0.01 cm-20 cm.

10. The method for activating the electric lock by the mobile phone according to claim 7, wherein the mobile phone is detected by the detection device of the electric lock once a distance between the mobile phone and the electric lock ranges 0.01 cm-20 cm.

11. The method for activating the electric lock by the mobile phone according to claim 8, wherein the mobile phone is detected by the detection device of the electric lock once a distance between the mobile phone and the electric lock ranges 0.01 cm-20 cm.
